(19) United States
(12) Patent Application Publication
(10) Pub. No.: US 2009/0040308 A1
(43) Pub. Date: Feb. 12, 2009

(54) IMAGE ORIENTATION CORRECTION METHOD AND SYSTEM

(76) Inventor: Igor Temovskiy, Rancho Palos Verdes, CA (US)

Correspondence Address: Lawrence S. Cohen, 10960 Wilshire Blvd., Suite 1220, Los Angeles, CA, 90024, US

(21) Appl. No.: 11/623,291

(22) Filed: Jan. 15, 2007

(51) Int. Cl. H04N 7/18; G06K 9/32

(52) U.S. Cl. 348/158; 382/296; 348/E07.085

(57) ABSTRACT

A system for correcting the rotational orientation of a targeting area provided by a weapon-mounted image sensor and an orientation sensor that detects the rotational orientation of the weapon. Measurements from the orientation sensor are used to transform the image data obtained from the image sensor into a desired rotational orientation. The transformed image data can then be displayed on a display in an orientation where objects having a vertical extent are displayed generally vertically.

### GOVERNMENT LICENSE RIGHTS

This invention was made with Government support under contract number NBCHC060083 from DARPA/DOI. The Government has certain rights in this patent.

### 1. FIELD

This disclosure relates to the field of correcting the orientation of a displayed image.

### 2. GENERAL BACKGROUND

Long term efforts to increase the effectiveness of the individual warfighter have centered mostly on the precision, range, and versatility of small arms. In the case of urban warfare, however, the space separating friendly from enemy forces compresses from thousands of meters in open battle to only tens of meters in an urban environment of densely aggregated buildings, streets, and back alleys. Further, the urban warfare environment may increase the exposure of the warfighter to weapon fire from multiple directions, even though the urban environment may also provide the warfighter an increased ability to find cover. Hence, it would be desirable for the urban warfighter to make use of this cover, while still being able to detect and direct fire onto targets. That is, there is a need for a warfighter to have the ability to designate and fire on a target without exposing the warfighter to return fire

One way in which a warfighter may detect and direct fire is through the use of a weapon-mounted camera. The camera can provide images within the line of fire of the weapon, which the warfighter can observe on a display, such as a head-mounted display. For example, a warfighter may be able to hold his weapon around the corner of a building, which provides the warfighter cover, while a weapon-mounted camera and head-mounted display shows the warfighter objects that can be targeted by the weapon. Typically, the weapon-mounted camera is mounted on the weapon so that the pointing direction (i.e., aiming axis) of the weapon, is in the view of the line of fire of the weapon.

Typically, a camera will be oriented to provide an upright image, that is, an image where objects having a vertical extent (telephone poles, buildings, trees, etc.) will be viewed with an orientation that is generally parallel to the force of gravity and objects having a horizontal extent will be viewed with an orientation generally parallel to the ground. For example, the user of a digital camera will typically bring the camera to eye level and orient the camera so that the horizontal axis of the camera is generally parallel to the horizontal lines in the scene being viewed, e.g., a floor, a ceiling, the tops or bottoms of doors, etc., and the vertical axis of the camera is generally parallel to the vertical lines in the scene. This allows the user to view items in a scene having a vertical extent in a generally vertical direction and items having a horizontal extent in a generally horizontal direction. See, for example, FIG. 1, which shows an image 10 in its conventional orientation. However, in an urban warfare environment, a camera mounted on a weapon is likely to be tilted, since the warfighter is more likely to be concerned with identifying and engaging a target, rather than obtaining a properly oriented image. Most importantly, it is likely that the weapon may be held such that any images obtained from the weapon-mounted camera will be rotated from the conventional upright orientation. See, for example, FIG. 2, which depicts the image 10 captured by a camera that has been rotated by 45°.

It is believed that the human brain naturally processes objects (especially moving objects) within an image or series of images more easily when they appear in an upright orientation, that is, items having a vertical extent should appear generally vertical and items having a horizontal extent should appear generally horizontal. For example, if a person is handed a picture that depicts a severely tilted scene, the person may just rotate the picture to a more standard orientation before attempting to determine what the scene actually depicts. When viewing a captured tilted static or moving image, a person may react slower to significant details in the image than if the image was viewed in a non-tilted form. It is believed that the brain must do additional processing to convert the image back to a generally upright orientation before details can be extracted from the image and thus the processing of the image is slowed. In general when an image is significantly tilted the brain will react to details in the image more slowly than when the image tilt is absent or insignificant. Hence, it is preferred that all images provided to a viewer be presented with an upright orientation.

There exists a need for an aiming system that allows for a small arm to be quickly aimed and fired at a target without requiring the weapon to be brought to eye level for aiming and without unnecessarily revealing the location of the weapon or the warfighter. Further, there exists a need for a method and system that corrects the rotational orientation of an image from a sensor whose optical axis is parallel to the aiming axis, when the sensor is rotated around its optical axis and the image is viewed on a display having a different rotational orientation than that of the sensor.

Embodiments of the present invention will be better understood, and further objects, features, and advantages thereof will become more apparent from the following detailed description, taken in conjunction with the accompanying drawings.

### BRIEF DESCRIPTION OF THE DRAWINGS

FIG. 1 illustrates an image in a preferred orientation.

FIG. 2 illustrates an image that has been captured by a camera that has been rotated by 45° around its optical axis.

FIG. 3 illustrates coordinate systems used with a viewer, a camera, and a display

FIG. 4 illustrates a head-mounted display screen that is displaying a magnified image of a background scene.

FIG. 5 illustrates the head-mounted display of FIG. 4 when the head-mounted display is receiving an image that has been rotated by 45°.

FIG. 6 shows an embodiment of the present invention where helmet-mounted cameras detect control marks disposed on a weapon.

FIG. 7 depicts a helmet-mounted display from the embodiment shown in FIG. 6.

FIG. 8 shows an embodiment of the present invention where rotational orientation sensors provide data regarding the rotational orientation of a weapon-mounted camera.

FIG. 9 depicts a scene viewed by a soldier wearing a head-mounted display.

FIG. 10 depicts a display screen according to an embodiment of the present invention in which a projectile line replaces a cross-hair.

FIG. 11 depicts a display screen according to an embodiment of the present invention in which a projectile line also includes range information.

FIG. 12 depicts a display screen according to an embodiment of the present invention that includes video from a weapon-mounted camera.

FIG. 13 depicts a display screen according to an embodiment of the present invention that includes video from a weapon-mounted camera, where the weapon-mounted video display is aligned with a projectile line.

FIG. 14 depicts a display screen according to an embodiment of the present invention that includes video from a weapon-mounted camera, where the weapon-mounted video display is aligned with an aimpoint of the weapon.

FIG. 15 shows a system for rotational correction.

FIG. 16 shows a block diagram of a system for rotational correction.

FIG. 17 shows the display of a rotationally corrected image within a larger display.

FIG. 18 illustrates a system for rotational correction as used by a warfighter.

FIG. 19 illustrates the head-mounted display of FIG. 5, where the image within the display has been corrected according to an embodiment of the present invention.

FIG. 20 illustrates the head-mounted display of FIG. 19, where the rotational orientation of the camera providing an image has been corrected, but the image has not been corrected for head tilt.

FIG. 21 illustrates the head-mounted display of FIG. 20, the image within the head-mounted display has been corrected for camera rotation and head tilt according to an embodiment of the present invention.

FIG. 22 is a block diagram of the steps that may be used for the processing for rotational orientation correction for two-dimensional images

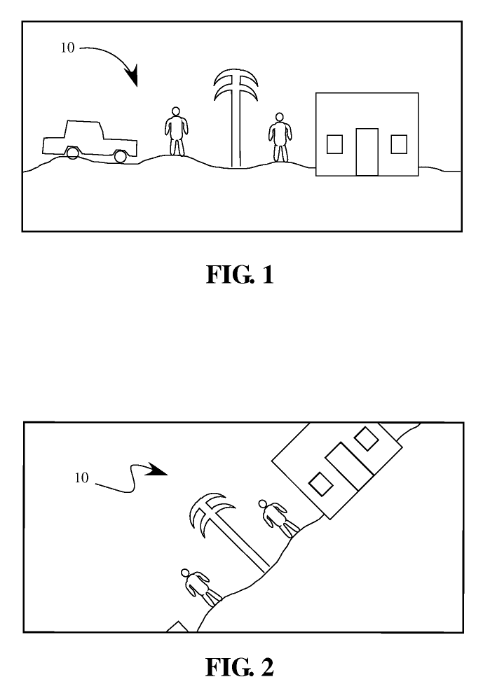

### DETAILED DESCRIPTION

For purposes of this disclosure and for interpreting the claims, the following definitions are adopted. The term “image sensor” refers to an apparatus that detects energy in the near infrared, infrared, visible, and ultraviolet spectrums to be used for the formation of a displayed image based on the detected energy. The term “image sensor” may also refer to an apparatus that detects energy in the radio frequency spectra below optical frequencies, including, but not limited to, microwave, millimeter wave and terahertz radiation. The term “image sensor” may also refer to an apparatus that detects energy in other forms, such as sonar, for the formation of a displayed image. The detected energy may be used to form a single static image or a series of images (such as from a video camera) that may provide a moving image. The apparatus may comprise conventional optical sensing devices such a charge-coupled detector (CCD) or CMOS cameras, tube-based cameras or other optical sensors that produce an image/video or images of a viewed scene. Detection devices within the image sensor may be deployed in a planar arrangement in a two-dimensional orientation, where the detection devices (e.g. detection pixels) may be considered as being in rows and columns or in horizontal lines (e.g. . . . for analog video). The output of the apparatus may be one or more analog signals or one or more digital signals. The term “camera” may be used interchangeably with the term “image sensor.” The term “imaging axis” refers to the pointing direction of the image sensor and corresponds to the optical axis of the optical system associated with the imaging sensor. Typically, the imaging axis will be perpendicular to the plane of any detecting devices in the image sensor. For example, in an optical image sensor, the imaging axis or optical axis will be perpendicular to the optical detectors in the sensor or perpendicular to any optical lens used to focus optical energy onto the optical image sensor.

A method and apparatus for correcting the rotational orientation of an image or series of images obtained from a sensor are described below. More particularly, this detailed description describes the correction of the rotational orientation of an image or series of images when the image or series of images are transferred to a system having a different frame of reference (orientation) than that of the sensor that captured the image or series of images. For purposes of this disclosure and for interpreting the claims, the term “rotational orientation” refers to the angular orientation of the vertical portions or horizontal portions of an object recorded by a sensor or displayed on a display with respect to a designated common perceived vertical and horizontal orientation such as a world coordinate system or a main coordinate system The world coordinate system as used herein is a Cartesian coordinate system that is affixed to a point on the earth or to a non-moving target.

Embodiments of the present invention may include the display of images or video obtained from a weapon-mounted imaging sensor for display on a head-mounted display, where the images or video are modified to compensate for the rotational orientation of the imaging sensor and/or the head-mounted display. The head-mounted display may have see-through capabilities that support the display of a digital aim point along with other information and may also include a picture-in-picture or full screen video image from a weapon-mounted camera. The head-mounted display preferably provides a minimal obstruction of the field of view. Such a display may allow for the use of simpler optics for sighting a weapon and may also allow the use of miniature optical systems that preserve the quality of an image or video obtained from a weapon-mounted camera that is displayed on the head-mounted display.

Some embodiments comprise a rotational orientation sensor on a weapon along with an image or video stream obtained from a weapon-mounted image camera. Other embodiments comprise an orientation sensor on a weapon and an orientation sensor attached to a user's head that allows for the display of the aiming direction of the weapon as a digital aim point on a head-mounted display. Still other embodiments may comprise a rotational orientation sensor on a weapon and a weapon-mounted camera and a rotational orientation sensor attached to user's head that allows for the display of the direction of the weapon as a digital aim point on a head-mounted display along with an image or video stream obtained from a weapon-mounted image camera displayed on the head-mounted display. Still other embodiments of the present invention may also display digital aim positions of a team, group, or squadron and other information linked to a particular direction and/or spatial coordinates and may also have the ability to store video and sensor information.

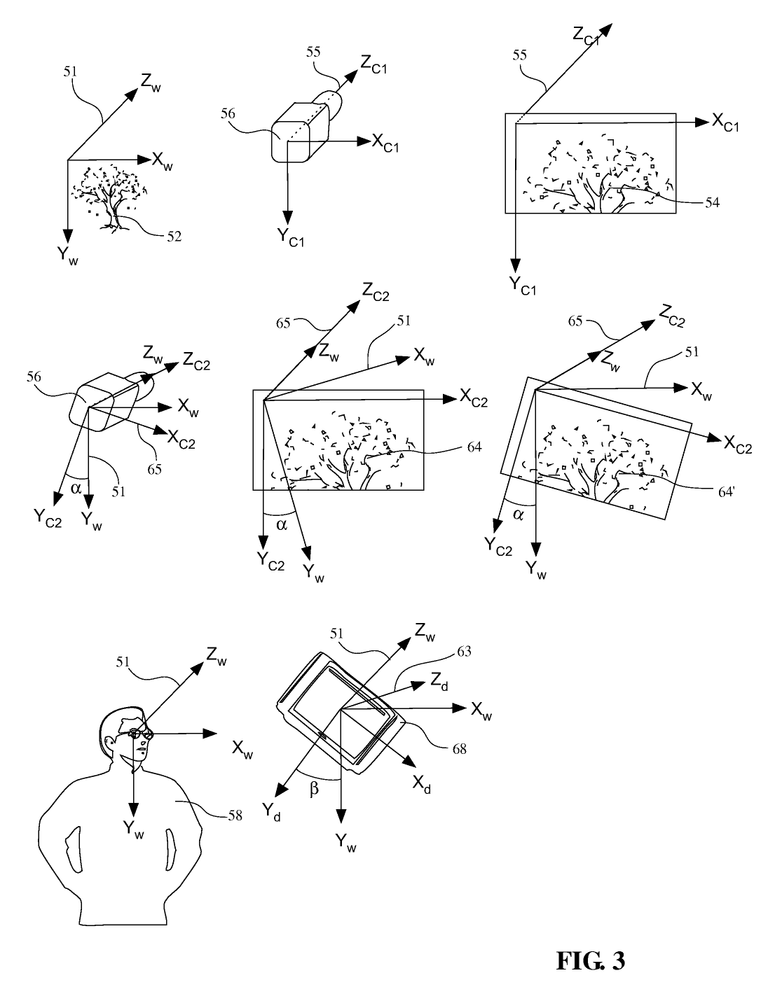

FIG. 3 shows the various coordinate systems at play when an image sensor is used to capture an image. The world coordinate system X_{w}Y_{w}Z_{w} 51 is based on a world coordinate system, which represents how a human viewer 58 would see an object 52. A non-rotated camera coordinate system X_{C1}Y_{C1}Z_{C1} 55 represents the coordinate system of a camera 56 with the optical axis of the camera represented by the Z_{C1} axis capturing an image 54 of the object 52. If the camera 56 has a row and column orientation, the axis X_{C1} corresponds to the rows direction and the axis Y_{C1} corresponds to the column direction. A rotated camera coordinate system X_{C2}Y_{C2}Z_{C2} 65 represents the coordinate system when the camera 56 is rotated by the angle α around the optical axis Z_{C2}. Accordingly, the image 64 is also rotated by the angle α with respect to the world coordinate system X_{w}Y_{w}Z_{w} 51. Hence, an image with angle α=0 would be considered as being an “upright image.” Finally, the image from the camera 56 may be sent to a display 68, which may also be rotated or have a tilt based on the angle of the user's head and would have a display coordinate system X_{d}Y_{d}Z_{d} 63. If the display 68 has a row and column orientation, the axis X_{d} corresponds to the rows direction and the axis Y_{d} corresponds to the columns direction. In use the display 68 may be rotated or have atilt from the world coordinate system X_{w}Y_{w}Z_{w} 51 by the angle β, so any images displayed on the display 68 would be rotated back by the angle β if the viewer 58 of the display was oriented in the same orientation as the world coordinate system X_{w}Y_{w}Z_{w} 51 and the images are to be displayed in the world coordinate system orientation. Therefore, a displayed image should be considered as being an “upright image” if the image is displayed on the display 68 in an orientation generally equivalent to the orientation of the world coordinate system.

The brain also processes scenes such that even if a person tilts his or her head left of right, the verticality or horizontalness of an item is still recognized because the brain also processes input from the vestibular system. That is, when a person tilts his or her head, the scene as viewed by the eyes of the person does not appear to tilt. However, if an image displayed to a user is tilted, a person will typically recognize that the image has been tilted. In this context, the term “tilt” refers to the rotational orientation of the image.

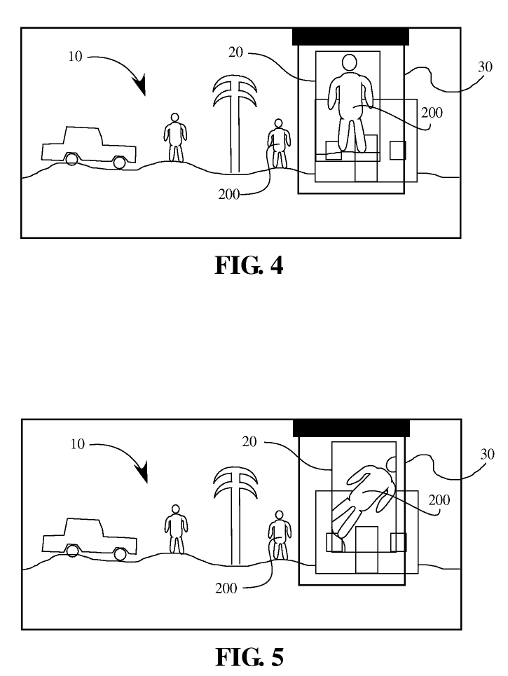

The impact of a tilted scene may become most critical when the image containing a scene is transmitted to a display device for which the user does not have the ability to physically rotate the display device, and in particular when a limited scene content, such as a magnified view, appears so that rotational orientation clues may be limited or absent or the scene is moving. For example, a digital camera mounted on a hand-carried weapon may be used to capture the aim point of the weapon. Images from the digital camera could then be transmitted to a display worn by the soldier carrying the weapon. The display may be head-mounted or mounted in some other way on the user's body. It may be a see-through or “heads-up” display. If the rotational orientation of the digital camera matches the rotational orientation of the head-mounted display, the soldier is able to view both scenes in the world coordinate system orientation, even though the scene from the digital camera may be magnified. See FIG. 4, which shows the background image 10 and a magnified image 20 of a target 200 displayed on a see-through display screen 30. However, if the digital camera is rotated around its optical axis, the scene from the digital camera will be rotated. See FIG. 5, which shows the magnified image 20 of the target 200 rotated by 45°. This rotation of the image may slow the soldier's reaction time (increase cognitive load) to critical aspects in the scene from the digital camera.

Embodiments of the present invention may utilize a calculation of the rotational orientation of a camera along its optical axis in order to enable presentation of the image to the viewer with respect to the world coordinate system (also referred to as an upright image). This is done by determination of the angular difference from the world coordinate system, and processing the image data to display it as in the world coordinate system Returning to FIG. 3, if the camera 56 is rotated by angle α, it will provide an image tilted by that angle. When presented to the viewer the image 64 is rotated back on the same angle α, so that the display to the viewer showing the image is oriented with a rotational orientation equivalent to the world coordinate system, that is, the viewer sees an upright image 64′. In a further embodiment, if the display 68 is rotated with respect to the world coordinate system by the angle θ, the image 64 on the display 68 is preferably rotated by the difference between α and β. In this way, if the viewer's head is tilted so as to tilt the display, that tilt will be corrected and the viewer will see an upright image. This can be done by use of a sensor that senses the rotational orientation of the display relative to the world coordinate system.

An embodiment of the present invention utilizes rotational detection and correction to assist a soldier in detecting and tracking the aiming direction and aimpoint of a weapon. A weapon-mounted camera provides images of the aiming direction of a weapon and may also specifically depict the aimpoint of the weapon. However, as discussed above, the weapon may be held such that the images obtained from the weapon may be rotated from an upright orientation. Therefore, an embodiment of the present invention provides for the detection of the rotational orientation of the weapon (and, therefore, the rotational orientation of the weapon-mounted camera) and modifies images from the camera based on that rotational orientation and displays the modified images on a head-mounted display.

In the general case of a weapon that fires a projectile, the barrel or tube direction determines an aim point. control marks on the barrel or tube are used to calculate the aiming direction relative to the scene on the camera; whose axis is preferably, but not necessarily parallel to the aiming direction—any known orientation can be taken into account in the calculations done by the processing system. Of course, the shooting direction should be in the field of view of the camera. FIG. 6 depicts an embodiment which uses cameras to track control marks on a soldier's weapon. FIG. 6 shows a soldier 610 wearing a helmet 620 and carrying a weapon 601. The helmet 620 has cameras 622 mounted on it along with a full-face helmet-mounted display system 624. FIG. 6 depicts two helmet-mounted cameras 622, but other embodiments of the invention may have only a single camera 622 or more than two cameras 622. Control marks 612 are located on the weapon 601. FIG. 6 depicts two control marks 612 on the weapon 601, but other embodiments of the invention may have only a single control mark 612 or more than two control marks 612. A camera 630 is mounted on the weapon 601 and oriented along the axis of the weapon 601. This weapon-mounted camera 630 preferably provides an image of the aim point of the weapon 601.

The control marks 612 are preferably positioned on the weapon to be in the field of view of the helmet-mounted cameras 622. The helmet-mounted cameras 622 receive images containing the control marks 612. These images are then digitally processed to determine the orientation of the weapon 601 relative to the helmet-mounted cameras 622. Further processing is then performed to determine the aim point of the weapon 601 relative to the soldier's field of view as seen on or through the helmet-mounted display system 624. This aim point is then displayed by the helmet-mounted display system 624.

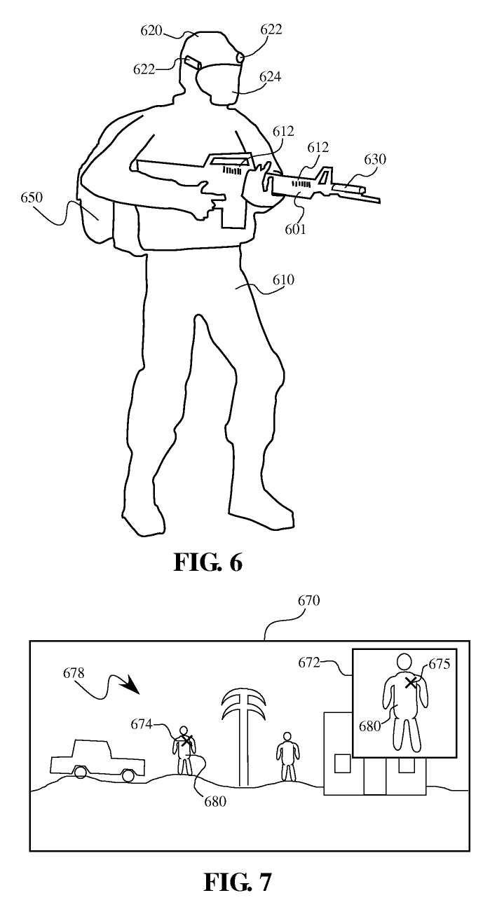

FIG. 7 depicts a display 670 provided by a helmet-mounted display system 624. The helmet-mounted display system 624 is preferably a “see-through” (sometimes also called a “heads-up” display) system where the display 670 has images projected on it, while also allowing the soldier to view the real scene behind the display 670. Several types of display are available, such as a full-face transparent screen, a small eye screen and others known in the art. Preferably the display should not interfere with the user's field of view, and can, optionally, be moved out of the user's field of view. The display 670 comprises a background scene 678, a targeting crosshair 674 positioned on a target 680, and, in preferred embodiments, an image 672 from the weapon-mounted camera 630 with a precise aiming crosshair 675. The background scene view 678 may be the view through the helmet-mounted display 670, or an image projected onto the helmet-mounted display 670. The targeting crosshair 674 is projected onto the helmet-mounted display 670 and the position of the targeting crosshair 674 is based on the calculations of the orientation of the weapon 601 relative to the helmet-based cameras 622 and the aim point of the weapon 601. A weapon-mounted camera image 672 is also projected onto the helmet-mounted display 670 and may be located anywhere with the display 670. The weapon-mounted camera image 672 may comprise a “zoomed” image with the amount of zoom manually or automatically controlled.

The control marks 612 may comprise two-dimensional matrix barcodes, such as DataMatrix or “Quick Read” (QR) barcodes. Preferably, unique messages are encoded in the control marks when deployed on the weapon 601. These unique messages then allow the identification of unique object orientation/correspondence points. Barcodes are particularly adapted for the encoding of messages. As an example, control marks 612 consisting of four barcode messages may be positioned on the weapon 601, where each message indicates the location of the barcode on the weapon 601, e.g., left front, right front, left back, right back. Further, techniques are known in the art for reading barcodes with significant distortion, such as distortion caused by image orientation, motion, or other imaging effects. It is also preferred that the barcodes be painted on the weapon 601 with paint that is not visible in the visible light spectrum, such as near-infrared wavelength paint or ultraviolet responsive paint.

Digital processing may be used to process the image data to determine the image orientation. The digital processing may be performed by one or more processors disposed in numerous locations. For example, the processors may be located within the helmet 622, the weapon 601, or, if additional space is needed, within a back pack 650 carried by the soldier. Connections between the cameras 622, 630, the processors, and the helmet-mounted display 624 may be made by wired or wireless connections.

An embodiment of the present invention comprises one or more rotational orientation sensors on a soldier's weapon. In another embodiment, orientation sensors may also be deployed on a soldier's head or helmet; along with the processing system being programmed to calculate a tilt correction using both the output of the weapon mounted rotational sensor and the head mounted rotational sensor, so the image will appear upright to the user even though his head is tilted. This approach takes into account the adjustment on the head mounted display versus the weapon shift that could be eliminated by a calibration procedure. The soldier also has a head or helmet mounted display.

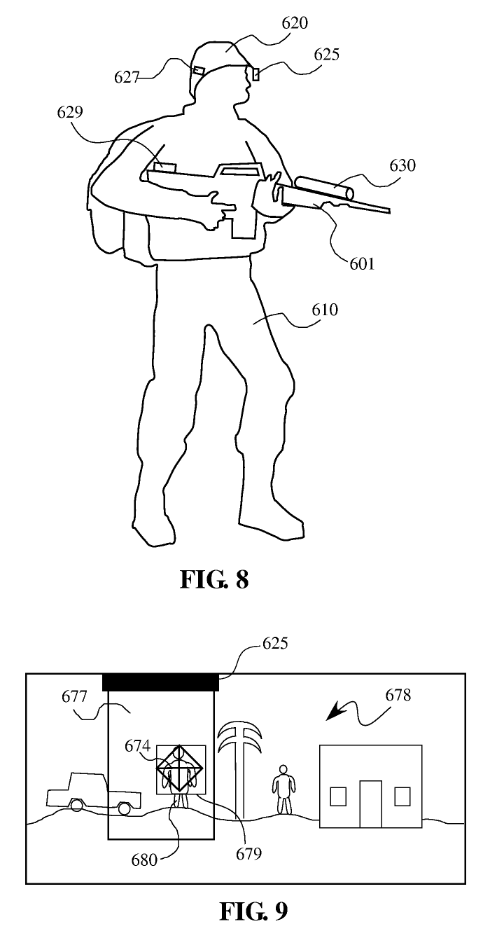

FIG. 8 depicts an embodiment in which orientation sensors are used. FIG. 8 shows a soldier 610 wearing a helmet 620 and carrying a weapon 601. The helmet 620 has one or more orientation sensors 627 mounted on it along with a flip-up helmet-mounted display system 625. Note that a full-face display system 624, as shown in FIG. 6, may be used in embodiments of the invention generally depicted in FIG. 8. Similarly, a flip-up display 625 may be used in embodiments of the invention generally depicted in FIG. 6. One or more orientation sensors 629 are also located on the weapon 601. A camera 630 is mounted on the weapon 601 and oriented along the axis of the weapon 601. This weapon-mounted camera 630 provides an image of the aim point of the weapon 601.

The weapon-mounted camera 630 may comprise a simple compact video camera. However, a digital rifle scope, such as ELCAN's Digital Hunter RifleScope, is preferred, since such scopes typically hardening (protected) housing and mount and professional rifle-targeting calibrations and eliminate many of the inadequacies of more compact rifle-based cameras. The weapon-mounted camera 630 does provide image data representing the aim point of the weapon. The weapon-mounted camera 630 also preferably provides an automatic or manual zoom capability to allow the weapon to be more accurately aimed. The weapon-mounted camera 630 preferably provides streaming video, generated by the processing system, of the aim point of the weapon 601 that also can include crosshairs that indicate the aim point of the weapon 601.

The head-mounted orientation sensors 627 and the weapon-mounted orientation sensors 629 may comprise a local magnetic field position tracking sensor, such as the Polehmus tracking sensor. This system does provide the ability to track the relative orientation between the soldier's head and the weapon. However, such a system creates a magnetic field that may be sensitive to metals and the sensors must generally be kept within 2 feet of each other for the system to properly operate.

The head-mounted orientation sensors 627 and the weapon-mounted orientation sensors 629 may comprise any of a number of rotational orientation sensors or inclination sensors to show deviation from upright, (i.e., inclinometers, gyroscopes, and magnetometers and combinations thereof) known in the art. Products such as the Digital Magnetic Compass and Vertical Angle Sensor (DMC-SX) from Vectronix AG of Heerbrugg, Switzerland; the DLP-TILT tilt sensor from DLP Design, Inc. of Allen, Tex.; or the 3-D Pitch, Yaw, Roll sensor 3DM from MicroStrain, Inc. of Williston, Vt. may serve as the requisite rotational orientation sensors along with other products known in the art. Such sensors are typically sensitive to rotation on three axes and can, therefore, provide data on the rotational orientation of the soldier's head and the weapon. However, some rotational orientation sensors may be sensitive to ferric metals such as iron, which may limit their usefulness in some applications. A preferred rotational orientation sensor provides rotational orientation data without relying on the use or detection of magnetic fields.

As indicated above, the weapon-mounted camera 630 provides streaming video to the head-mounted display 625. The head-mounted display 625 may comprise a screen that is present at only the soldier's right or left eye, a single screen or multiple screens viewable by both eyes, or screens that are separately viewable by each eye (which may be used to provide a three-dimensional viewing capability) Preferably, the streaming video is not presented as a full-screen version of the images from the weapon-mounted camera 630, but as a smaller scale picture that shifts on the screen corresponding to the movement of the weapon 601. The streaming video may comprise the entire image obtained from the weapon-mounted camera 630 or just a portion of the image.

FIG. 9 shows a typical scene viewed by a soldier wearing the head-mounted display 625. The viewed scene comprises the actual background scene 678 while an image 679 is presented on the screen 677 of the head-mounted display 625. The screen 677 preferably comprises a “see-through” screen that allows for displays to be projected on it while also allowing the real scene 678 beyond the display to be viewed through it. The weapon-mounted camera picture 679 appears on the head-mounted display 625 positioned over the intended target 680. The weapon-mounted camera picture 625 may also contain a cross hair or other indicator 674 that indicates the aim point of the weapon 601 as provided by an aimpoint display system.

Data from the rotational orientation sensors 627, 629 is used to calculate the relative orientation of the soldier's head to the weapon 601, which may then be further used to determine the rotation of the small scale picture 679 within the head-mounted display screen 677. As either the orientation of the weapon 601 or soldier's head changes, the position of the weapon-mounted camera picture 679 within the head-mounted display screen 677 may change. Zoom capability provided by the weapon-mounted camera 630 will preferably provide the ability to zoom the weapon-mounted camera picture 679 within the head-mounted display screen 677.

Provided with a weapon-mounted camera 630 and display 625, a soldier is able to aim and fire at threats, completely covered, with only the weapon-mounted camera 630 and the weapon 601 visible. For example, the soldier may be able to extend his weapon around the corner of a building, and view the target area of the weapon in the display. By observing the images from the weapon-mounted camera, the soldier can determine a target and can then use an aim point provided on the display to move the weapon to precisely aim at a target. The weapon can then be fired, while the soldier is covered from any return fire. In a close quarter environment (e.g., when clearing rooms or an urban environment), cover is extremely important for a soldier. Embodiments of the present invention allow for the soldier to maintain maximum cover when engaged in a close combat firefight. Furthermore, the soldier is able to utilize the cover to steady his rifle, to allow for a more precise shot.

Embodiments of the present invention allow for a sharpshooter to have maximum cover. Using the invention, the sharpshooter can place the weapon away from his body. If the sharpshooter is aiming through the weapon-mounted camera, enemy forces, upon seeing the weapon-mounted camera, will target the weapon-mounted camera. Should the enemy successfully hit the weapon-mounted camera, the soldier is not likely to suffer serious injury because the weapon is away from his body, and he is under cover. Embodiments of the present invention allow the soldier to target the enemy from complete cover, and in case of successful retaliatory fire, only the weapon-mounted camera would be exposed to damage.

Embodiments of the present invention are also suitable for training applications since the information presented on the head or helmet mounted display can be cloned on a separate display and/or recorded. This feature lends itself for close analysis of a soldier's shooting methods and style. For example, soldiers are trained to keep their weapon level (i.e., not tilted in either the left or right direction), to prevent discrepancies between the aim and the path of the projectile. Soldiers, who habitually tilt their weapon without realizing it, would be able to analyze their mistakes in a recorded video of the helmet or head mounted displays. Other issues in aim and precision would be better analyzed, as the instructor will be able to see, in real time, through the soldier's “eyes.”

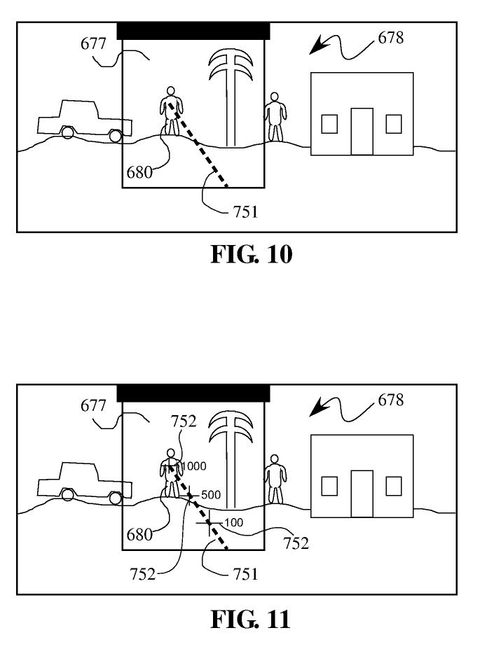

Embodiments of the present invention may replace the single aiming cross-hair on the display with a display of the projectile trajectory. FIG. 10 shows a display on a head-mounted see-through screen 677 where a projectile line 751 replaces a cross-hair. This projectile line 751 shows the line of fire from a weapon. The calculation of the display of the projectile line 751 is again based on the orientation of the display and the weapon as discussed above. Another embodiment of the present invention may also include range-providing cross hairs 752 on top of the projectile line 751 to provide additional aiming information to the user, as shown in FIG. 11. A stereoscopic heads-up display may be used to provide a three-dimensional representation of the projectile line 751 and/or the range-providing cross-hairs 752.

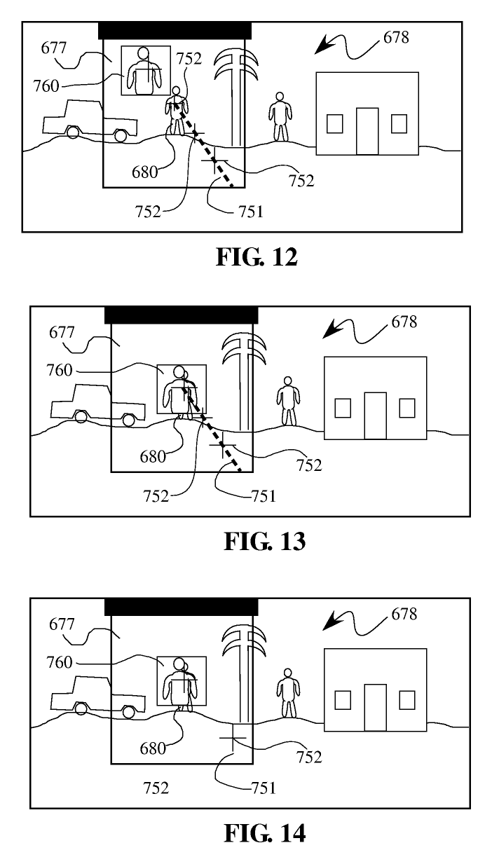

Other embodiments of the present invention may augment the head-mounted display by inserting normal or magnified video from a weapon-mounted camera. FIG. 12 shows a small display 760 of the video from the weapon-mounted camera within the screen 677 of the head-mounted display. This display provides a magnified image of the aim point of the weapon, which provides the user with additional aiming accuracy. In this case, the small display (i.e., picture-in-a-picture) remains at the same location within the head-mounted display screen 677. Another embodiment of the present invention moves the weapon-mounted video display 760 within the head-mounted display screen 677 to, for example, match the aim point of the weapon, as shown in FIG. 13. The projectile line 751 is also displayed. The weapon-mounted video display 760 is aligned with the projectile line 751 so that the cross-hair of the scope appears at the location where the line of fire intersects the target 680, or at some predetermined distance along the line of fire. The projectile line 751 may also include range-designating cross-hairs as shown in FIG. 11. Another embodiment may remove the projectile line, so that only a near-field mark 752, denoting the beginning of the line of fire, along with the weapon-mounted video display 760, is shown on the head-mounted display screen 677, as shown in FIG. 14.

Two displays may be used, one for each eye, to provide the user with trajectory lines and/or video images from the weapon-mounted camera as stereoscopic pairs. This will result is a three-dimensional image of the aiming information that appear to “float” in front of the viewer, thereby providing the viewer aiming information that includes depth perception.

A concern about including video images on the head-mounted display is that the video images may be rotated from the “world view orientation” or “world coordinate system” orientation. That is, rotation of the weapon-mounted camera may cause any images from the weapon-mounted camera displayed on the head-mounted display to appear to be rotated from the world view orientation, i.e., not in an upright orientation. As discussed above, this may slow the reaction time of the soldier viewing the display. Hence, embodiments of the present invention preferably provide apparatus to correct this rotation. Note also that this rotation correction may also be applied in other situations where an imaging sensor captures an image and the image is sent to a display that may have a different orientation that the imaging sensor.

One embodiment of the present invention comprises a digital camera with a rotational orientation sensor mounted on the camera or on a structure carrying the camera, such as a weapon. The rotational orientation sensor detects any rotation of the camera and/or its carrying structure about an axis parallel to the optical axis of the camera and transmits information regarding that rotation to a processor. Digital processing of the stream of images received from the camera and the rotational orientation sensor data is used to rotate the stream of camera images to a new rotational orientation. Preferably, the new rotational orientation of the stream of images is configured to be in the standard orientation of a viewer, such that objects having a vertical extent are generally depicted with a vertical orientation. That is, as discussed above, the objects in the displayed images are preferably displayed in an orientation equivalent to the world coordinate system, i.e., an upright orientation.

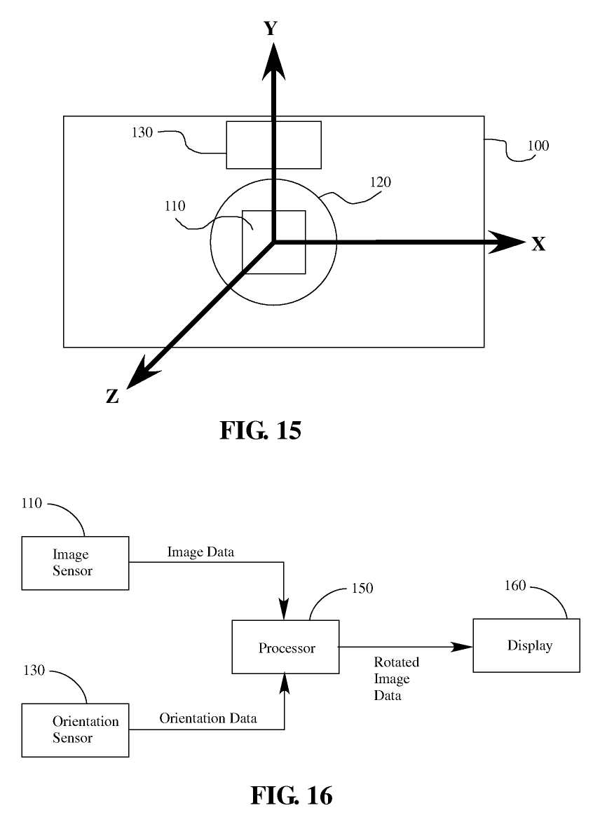

FIG. 15 depicts this embodiment. FIG. 15 shows a camera 100 with an image sensor 110, a lens 120 and a rotational orientation sensor 130. The optical axis of the camera 100 is shown by the axis labeled Z and the plane of the optical sensor 110 within the camera 100 is on the plane defined by the axis X and the axis Y. The rotational orientation sensor 130 detects any rotation of the camera 100 around the optical axis Z of the camera 100.

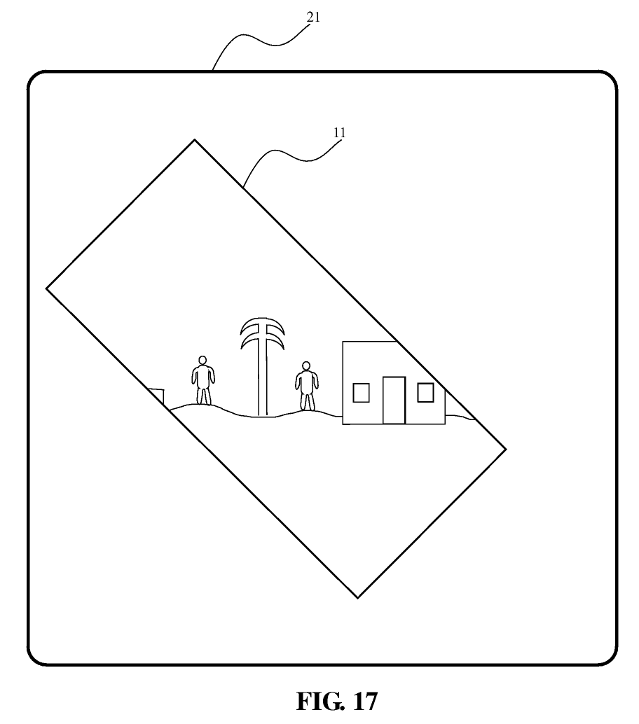

FIG. 16 shows a block diagram of system depicted in FIG. 15. The optical sensor 110 produces image data and the orientation sensor 130 produces orientation data. Both sets of data are transferred to a processor 150, which performs calculations to rotate the image data to a new preferred rotational orientation for display. The rotated image data may then be transferred to a display 160 for viewing. For example, if the camera 100 is rotated by 45° and no rotational correction is made before image data from the camera 100 is displayed, the display 160 will show an image like that seen in FIG. 2. If, however, a rotational correction of 45° is made and the images from the camera are displayed as a smaller display 11 within a larger display 21, the display 160 may show an image such as that seen in FIG. 17. That is, the display 11 has the preferred orientation of the world coordinate system, as discussed above.

The rotational orientation sensor 130 may comprise any of a number of rotational orientation sensors or inclination sensors to show deviation from the upright direction (e.g. inclinometers, gyroscopes, and magnetometers and combinations thereof) known in the art, such as those discussed above for use in determining the rotational orientation of a weapon or a soldier's head. Products such as the Digital Magnetic Compass and Vertical Angle Sensor (DMC-SX) from Vectronix AG of Heerbrugg, Switzerland; the DLP-TILT tilt sensor from DLP Design, Inc. of Allen, Tex.; or the 3-D Pitch, Yaw, Roll sensor 3DM from MicroStrain, Inc. of Williston, Vt. may serve as the desired orientation sensor along with other products known in the art. Such products may operate by measuring an orientation with respect to the force of gravity or with respect to the earth's magnetic field or other means known in the art. The requisite rotational orientation sensing may also be provided by analyzing the images from the camera itself to determine the amount that the camera has been rotated or been tilted from the upright or world coordinate system orientation.

As shown in FIG. 16, the orientation data may be provided in a separate stream from the image data, which may consist of either analog or digital data. In other embodiments, the orientation data may be combined with the image data to be provided as a single stream. If the image data is being provided as digital data, the orientation data can be embedded as digital data with the image data. For example, if the camera is provided a stream of images in digital format, each image could be tagged with orientation data that indicates the rotational orientation of that image. The rotational orientation can be based on the rotation of the camera from the gravity vector or some other given starting orientation.

The rotational orientation sensor 130 does not have to be mounted on the body of the camera 100 as shown in FIG. 15. Both the camera and rotational orientation sensor may be mounted on some sort of carrying structure, such that when the carrying structure is rotated, both the camera and rotational orientation sensor rotate. Preferably, the distance from the rotational orientation sensor, whether disposed on the camera body or on a carrying structure, to the optical axis of the camera is known so that the rotational orientation of the camera can be most accurately determined. If the distance is small enough, it can be ignored and the output of the rotational sensor can be used as the rotation of the image. The rotational orientation sensor 130 may supplemented or be integrated with sensor elements for detecting the pitch and yaw orientation of the optical axis and, hence, any tilt upward or downward or left or right of the plane of the optical sensor. These orientations can also be passed to the processor 150 to support additional image correction. However, changes in the vertical orientation (upward or downward) or horizontal orientation (left or right) of an image are believed to have less of an impact on the comprehension of a viewed image than a change in the rotational orientation of an image.

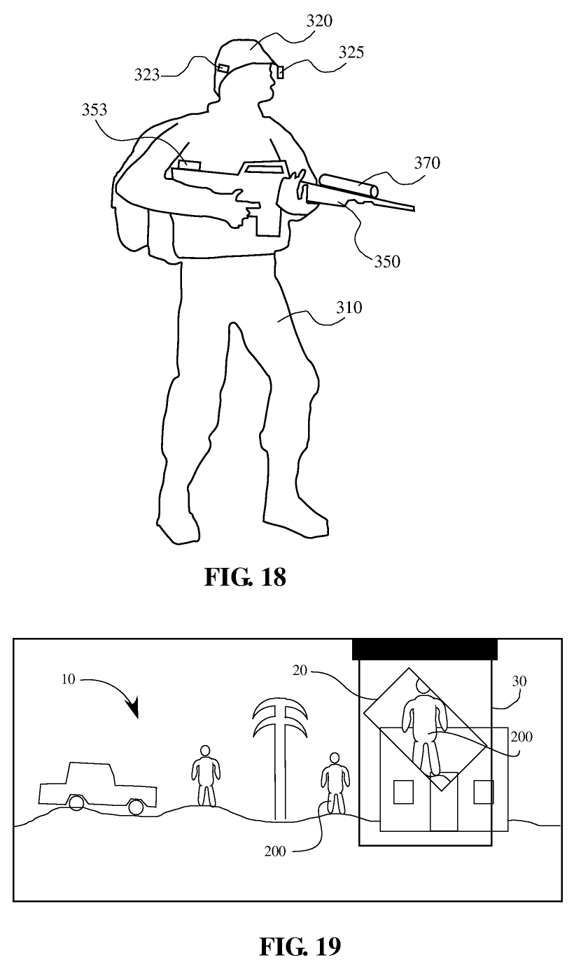

Another embodiment of the present invention may provide correction for the rotational orientation of an image received from a camera and the rotational orientation of the display presenting the image from the camera. In this case, a second sensor may be used to determine the rotational orientation of the display. FIG. 18 illustrates an example of this embodiment of the invention. FIG. 18 shows a soldier 310 wearing a helmet 320 and carrying a weapon 350. The helmet 320 has an orientation sensor 323 mounted on it along with a flip-up helmet-mounted display system 325. An orientation sensor 353 is also located on the weapon 350. A camera 370 is mounted on the weapon 350 and oriented along the axis of the weapon 350. This weapon-mounted camera 370 provides an image of the aim point of the weapon 350.

The weapon-mounted camera 370 may comprise a simple compact video camera or a more complex digital scope or other imaging sensors that provide image data representing the aim point of the weapon. The weapon-mounted orientation sensor 353 is preferably mounted on the weapon 350 in a manner so as to provide an output that most accurately reflects the rotational orientation of the camera 370 when the rotational orientation of the camera with respect to its optical axis changes. The helmet-mounted orientation sensor 323 detects when the rotational orientation of the soldier's head changes, i.e., when the head is tilted left or right.

A processor (not shown in FIG. 18) combines the orientation data from the head-mounted orientation sensor 323 and the weapon-mounted orientation sensor 353 to determine the overall rotational orientation corrections that must be made to the images from the camera 370 for display on the helmet-mounted display 325. Preferably, the rotational orientation of the images are corrected such that objects having a vertically extent are displayed as being generally vertical, i.e., objects are displayed that shows their relationship to the world coordinate system. FIGS. 19, 20 and 21 illustrate the rotational orientation corrections that may be made.

FIG. 19 illustrates an image similar to that of FIG. 5, which shows the background view 10 and a magnified image 20 of a target 200 displayed on a see-through display screen 30 from the helmet-mounted display 325. In FIG. 19, the soldier's head has not been tilted, but the weapon-mounted camera 370 has been rotated by 45°. Hence, without correction, the target would appear as shown in FIG. 5. However, the rotational orientation of the magnified image 20 has been corrected by 450 such that the target 200 appearing on the display screen 30 appears with the same general orientation of the other items in the background scene 10. One skilled in the art understands that the target 200 appearing in the screen 30 is more easily comprehended than the target appearing in the screen 30 shown in FIG. 5. Note that is FIG. 19, the helmet-mounted display 325 comprises a single screen 30 disposed in front of a single eye of the wearer. Hence, the magnified image 20 of the target 200 may not be coordinated with the scene as directed viewed. In an alternative embodiment, the background image 10 may be displayed on a screen and the location of the magnified image 20 may be coordinated with the display of the target 200 on the screen showing the entire background image.

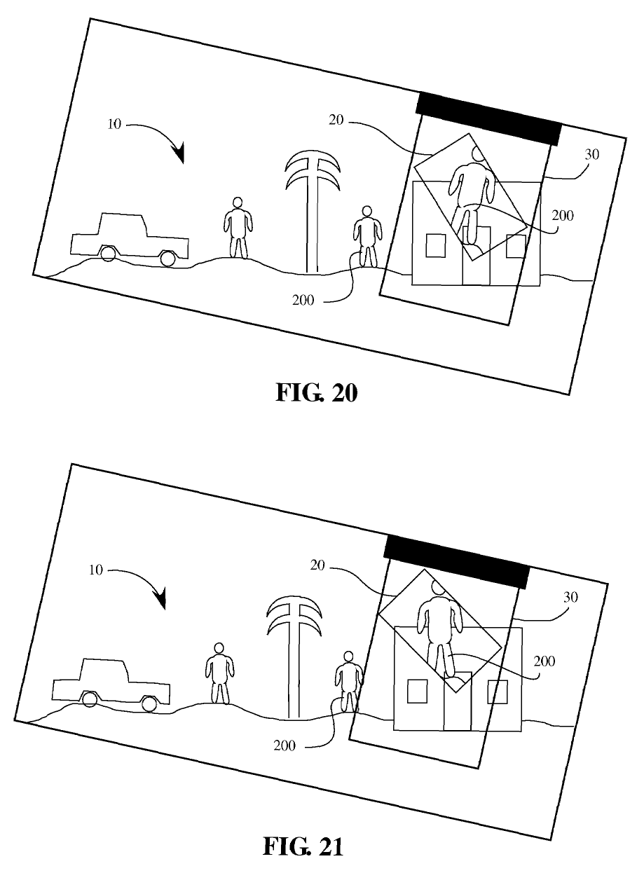

FIG. 20 illustrates an example when both the weapon-mounted camera 370 and the soldier's head is tilted, but where the single-eye display has not corrected for the soldier's head tilt. In FIG. 20, it can be seen that even though the display screen 30 presents a correction for the 45° rotation of the image from the weapon-mounted camera 370, the target in the screen 30 still appears at a different orientation than the items in the background scene 10 due to the soldier's head tilt.

FIG. 21 illustrates an example where corrections are made for both the rotation of the weapon-mounted camera 370 and the tilt of the soldier's head. In FIG. 21, the magnified image 20 is further rotated within the screen 30, so that the target again appears with the same general orientation as items in the background scene 10. As previously discussed, it is believed that images that maintain this standard orientation are easiest to comprehend and provide the fastest reaction times.

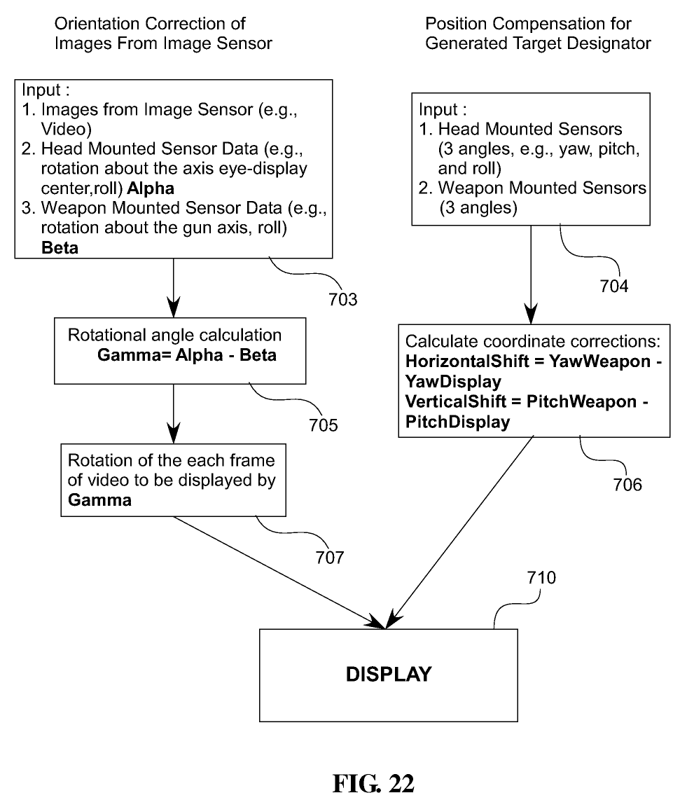

FIG. 22 shows a block diagram of the steps that may be used for the processing for rotational orientation correction for two-dimensional images. In FIG. 22, block 703 shows the collection of data from a weapon-mounted image sensor (e.g., video data), from a head-mounted sensor that detects head tilt, and from a weapon-mounted sensor that detects the rotational orientation of the weapon-mounted image sensor. Rotation of the head-mounted sensor from the world coordinate system orientation may be designated by the angle Alpha. Rotation of the weapon-mounted sensor from the world coordinate system may be designated by the angle Beta. Block 705 shows that the rotational correction applied to displayed images (i.e., the angle Gamma) may be calculated by subtracting Beta from Alpha. Block 707 shows that each displayed image (e.g., each video frame) will then be rotated by Gamma. Image rotation may be performed by computing the inverse transformation for every destination pixel. Output pixels may be computed using an interpolation. A typical example of the interpolation is bilinear interpolation. RGB images may be computed by evaluating one color plane at a time.

FIG. 22 also shows the processing that may be used to display a target designator (such as the cross-hair or projectile line discussed above) that is corrected for weapon orientation, head-mounted display orientation, or both. Block 704 shows the collection of data from sensors that provide 3 axis or 3 angle data for the position of the head and/or weapon (e.g., yaw, pitch and roll). Block 706 shows the calculation of corrected coordinates for the target designator based on the 3 angle orientation of the head-mounted display and/or the weapon. As shown in Block 706, the target designator may be repositioned in a horizontal direction based on the yaw orientation of the weapon minus the yaw orientation of the head-mounted display. Similarly, the target designator may be repositioned in the vertical direction based on the pitch orientation of the weapon minus the pitch orientation of the head-mounted display. These new coordinates for the target designator would then be sent to the head-mounted display for display.

Note that other methods or steps may be used for the correction of rotational orientation of an image or series of images to allow for the image or series of images to be displayed in an orientation that is substantially equivalent to the world coordinate system orientation (i.e., displaying an image or images as an upright image or images). For example, matrix arithmetic may be used to calculate the desired corrections, especially if the image or images are to be displayed in a three-dimensional fashion.

From the above descriptions it can be appreciated that the invention can be implemented in a number of viewing programs.

In one program (Program 1), the user will visually see the scene of interest. The screen can be interposed to see the scene through the screen which will be “black”, that is, transparent to the user. Of course in such case the system can be turned off or it can be in a ready condition for activation.

In another program (Program 2,) the entire image from the image sensor will be seen on the screen. The image will be rotated to the upright viewing orientation. No further information need be provided. This type of viewing will be useful when the weapon is positioned to look at a possible target scene will the user stays in cover. This program can then be the basis for the additional options as described.

In another program (Program 3), the picture-in-picture options can be available in combination with either of the first two programs described above. In the first combination (program 3 with program 1, Program 3-1), the user visually sees the entire scene of interest and the system inserts on the screen a resealed, rotated and partial version of the scene from the image sensor. The partial image will be rotated and can be scaled as desired, such as enlarged. In the second combination (program 3 with program 2, Program 3-2), the user sees a full image of the scene from the image sensor with a part of the scene cropped out of the image and superimposed on the full image at a desired rescale, such as enlarged.

These options can be selectable by the user and the features as described above can be implemented. For example, with Program 1 an aiming point can be displayed on the screen. With

Program 2, for example, an aiming point can be superimposed onto the image of the scene. The various options as described above can be implemented into the programs. Controls can be provided for the user, for example for scale adjustment, control of tilting, application of picture-in-picture and the like.

Other embodiments of the present invention may include other systems and methods which incorporate the apparatus and methods described above to determine relative weapon line-of-fire or rotational orientation correction. For example, it is not necessary for the warfighter to hold the weapon. If a remote (e.g. robotic) means of changing weapon orientation is provided, the heads-up display described above can be used to provide aiming information even if the user is physically removed from the weapon. Further, it is not necessary to use a heads-up display, nor is it necessary for the user to directly view the scene. For example, a remote operator, using virtually any type of display and any type of image source (e.g., video camera, IR camera, synthetic aperture radar (SAR), forward looking-infrared display (FLIR), imaging radar, etc.), can aim a weapon according to embodiments of the present invention. A manually or robotically controlled weapon's position and orientation can be determined using the control marks or orientation as described above. If the line of sight of the imaging apparatus is known and the position of the image source with respect to the weapon is also known, then the line of fire can be displayed as described earlier. In some cases, the line of sight of the imaging apparatus can be determined a priori; in other case, it can determined as described above by fitting the apparatus with control marks or orientation sensors.

Embodiments of the present invention have been discussed in the context of weapon-mounted cameras and helmet-mounted displays, but those skilled in the art understand that other embodiments of the present invention may be used in other applications. These other applications include, but are not limited to, commercial and consumer photography using digital or analog optical sensors, cameras mounted within cell phones, web cameras, etc. In general, embodiments of the present invention may find application in circumstances where a viewer of an image may have a different rotational frame of reference than that of the apparatus capturing the image.

The foregoing Detailed Description of exemplary and preferred embodiments is presented for purposes of illustration and disclosure in accordance with the requirements of the law. It is not intended to be exhaustive nor to limit the invention to the precise form or forms described, but only to enable others skilled in the art to understand how the invention may be suited for a particular use or implementation. The possibility of modifications and variations will be apparent to practitioners skilled in the art. No limitation is intended by the description of exemplary embodiments which may have included tolerances, feature dimensions, specific operating conditions, engineering specifications, or the like, and which may vary between implementations or with changes to the state of the art, and no limitation should be implied therefrom. This disclosure has been made with respect to the current state of the art, but also contemplates advancements and that adaptations in the future may take into consideration of those advancements, namely in accordance with the then current state of the art. It is intended that the scope of the invention be defined by the Claims as written and equivalents as applicable. Reference to a claim element in the singular is not intended to mean “one and only one” unless explicitly so stated. Moreover, no element, component, nor method or process step in this disclosure is intended to be dedicated to the public regardless of whether the element, component, or step is explicitly recited in the Claims. No claim element herein is to be construed under the provisions of 35 U.S.C. Sec. 112, sixth paragraph, unless the element is expressly recited using the phrase “means for . . . ” and no method or process step herein is to be construed under those provisions unless the step, or steps, are expressly recited using the phrase “comprising step(s) for . . . ”

What is claimed is:

1. A weapon system comprising:
an image sensor mechanically coupled to a weapon, wherein the image sensor has an imaging axis such that the direction of firing of the weapon is in the field of view of the image sensor and providing image data comprising one or more images or video of a targeting area of the weapon;
a first orientation sensor mechanically coupled to the weapon or the image sensor, wherein the first orientation sensor is disposed to detect a rotational orientation of the imaging axis;
one or more processors operative to receive image data from the image sensor and to receive rotational orientation data from the first orientation sensor, wherein the one or more processors are configured to modify an image orientation of the image data based on the received rotational orientation data to provide modified image data; and
a display configured to display the modified image data to a user,
whereby the targeting area of the weapon is displayed to the user with a rotational orientation correction that provides a display of the targeting area of the weapon with a rotational orientation substantially equivalent to a selected coordinate system.

2. The weapon system of claim 1, wherein the display comprises a display enabled to be in front of one or both of the user's eyes and the weapon system further comprises a second orientation sensor disposed to detect a rotational orientation of the display and wherein the one or more processors are configured to further modify the image orientation of the image data based on the detected rotational orientation of the display, whereby the display of the targeting area to the user has a rotational correction that compensates for any tilt of the display.

3. The weapon system of claim 1, wherein the selected coordinate system can be a world coordinate system or a main coordinate system

4. The weapon system of claim 1 wherein the image sensor comprises a CCD camera, a CMOS camera, or a tube-based camera.

5. The weapon system of claim 1, wherein the first orientation sensor comprises a sensor that is enabled to measure deviation from the upright direction.

6. The weapon system of claim 5 wherein the sensor comprises an inclinometer or a gyroscope or a magnetometer or a combination thereof.

7. The weapon system of claim 1, wherein targeting area of the weapon is displayed as a smaller picture within a larger picture shown on the display.

8. The weapon system of claim 76, wherein the targeting area of the weapon depicted in the smaller picture is substantially overlaid on the same depicted area in the larger picture.

9. The weapon system of claim 1, wherein the image sensor has an adjustable or fixed zoom capability.

10. A method for observing a target area of a weapon comprising:
obtaining image data from an image sensor, wherein the image sensor is coupled to the weapon and oriented to provide image data comprising one or more images or video of a targeting area of the weapon;
measuring a rotational orientation of the image sensor;
modifying the image data based on the measured rotational orientation;
displaying the modified image data to a user,
whereby the targeting area of the weapon is displayed to the user with a rotational orientation correction that provides a display of the targeting area of the weapon with a rotational orientation substantially equivalent to a selected coordinate system.

11. The method of claim 10, wherein the display is removably affixed to the user and the method further comprises:
measuring a rotational orientation of the display; and
further modifying the image data based on the measured orientation of the display, whereby the display of the targeting area to the user has a rotational correction that compensates for any head tilt by the user.

12. The method of claim 10 wherein measuring an orientation of the first carrying structure comprises measuring an orientation of the weapon with respect to the force of gravity and/or with respect to the earth's magnetic field.

13. The method of claim 10, wherein the modified image data is displayed as a smaller picture within a larger picture.

14. The method of claim 13, wherein the targeting area depicted in the smaller picture is substantially overlaid on the same depicted area in the larger picture.

15. The method of claim 10, further comprising:
calculating rotational orientation data based on the measured rotational orientation;
obtaining a digital representation of the modified image data; and
merging the calculated rotational orientation data with the digital representation of the modified image data to provide a digital data stream.

16. The method of claim 15 further comprising sending the digital data stream to one or more remote observers.

17. An image correction system comprising:
means for capturing an image;
means for measuring an orientation of the image; and
means for correcting the orientation of the image based on the measured orientation, wherein the means for correcting provides corrected image data.

18. The image correction system of claim 17, wherein the means for measuring the orientation of the image measures the rotational orientation around an imaging axis of the image.

19. The image correction system of claim 17, wherein a corrected orientation for the image is specified and the system further comprises means for displaying the corrected image data.

20. The image correction system of claim 17 further comprising means for measuring an orientation of a carrying structure and wherein the means for correcting provides corrected image data based on the measured orientation of the image and the measured orientation of the carrying structure.

21. The image correction system of claim 20 further comprising a means for displaying, wherein the means for displaying is coupled to the carrying structure and the means for measuring the orientation of the carrying structure measures the orientation of the means for displaying.
